(19) United States
(12) Patent Application Publication
(10) Pub. No.: US 2004/0210505 A1
(43) Pub. Date: Oct. 21, 2004

(54) System and Method for converting stock purchase credit awards in a company to stocks through centralized stock issuance exchange and trade system

(76) Inventor: Ahmad Pourhamid, Stockholm (SE)

Correspondence Address: JEFFREY FURR, 253 N. MAIN STREET, JOHNSTOWN, OH, 43031, US

(21) Appl. No.: 10/249,541

(22) Filed: Apr. 17, 2003

(51) Int. Cl. G06F 17/60

(52) U.S. Cl. 705/37

(57) ABSTRACT

An online/Internet based system and method for converting stock purchase credit awards or credit coupons that consumers obtain by purchase from the company, to the issuer's company stocks through centralized stock issuance, exchange and trade system. The consumers will earn a pre-assigned percent of purchase as a credit coupon for stocks on the issuing company. The seller will report the purchase and earned coupons to a central exchange for the registration. After consumer has accumulated enough credits for one or more stocks in issuing company, these credit coupons through a defined and computerized algorithm on the exchange system will be converted to stocks in the issuing company and consumer credits are reduced accordingly. From that point the consumer can freely trade the stocks, which is owned by the consumer. The system connects wirh banking systems to complete the transfer of funds to and from merchant and consumers.

### BACKGROUND OF INVENTION

This invention relates to a purchase credit awards and credit coupon generation system, more particularly, to a system wherein an amount equal to the value of redeemed coupon/credit awards is converted to stocks in the company which issues the coupons.

### DESCRIPTION OF PRIOR ART

Coupons or credit award incentive systems have long been used to provide an added incentive for the consumers to enter a transaction with issuers of coupons. While coupons and other reward programs, such airline frequent-flier programs are very common, these programs do not generate any loyalty to the issuers of incentive programs and therefore the consumer can easily change the suppliers. The key to consumer retention and loyalty is to make the consumer actively interested in the issuer by making consumers a part owner of the issuer company.

While the U.S. Pat. No. 5,970,480 to Kalina (1999) and U.S. Pat. No. 5,991,736 to Ferguson (1999) shows the use of financial instruments and retirement accounts for purpose of incentive award systems, these patents will fail to generate any loyalty to a specific issuer of coupons since the underlying coupons can be converted to many form of investments. It is also costly for the issuing company and the consumer to convert these to financial instruments and will be difficult for a customer without knowledge in investment field to chose the form of investment. The U.S. Pat. No. 5,233,514 to Ayyoubi (1993) has tried to address the issue of loyalty by purchasing the stocks of underlying issuer but it requires that the issuer is publicly traded company. This above patent does, not provide any solution for companies that are not publicly traded. The method and system for issuance of new common stocks to the consumer is also not addressed. Therefore, this approach is not applicable to newer or smaller companies that make a large part of the economy. In addition, the matter of cost effectiveness is not addressed, since a large portion of credit amount can be lost in the form of trade commissions to the financial institutions.

Our computerized Internet system and method for stock issuance through purchase credit coupons and arranging the trade in those stocks will be beneficial both to companies and consumers and therefore will have a positive effect on overall economy.

On one hand, consumers will get economic benefits of owing stocks of different companies, simply by purchasing from that company which in most likelihood, they would have done anyway. The consumer will also have a sense of loyalty to the issuer since the growth of issuer's company will also results in higher stock price which will benefit the consumer. This will be an easy introduction for many people who are not use to stocks and stock trade to familiarize them with the concept, and participate in it. The stock ownership of local companies also provides the consumer with a sense of participating in the local economy and results in a community spirits. The economic benefit of such stockowner ship, in a long run can provide the consumer with financial resources necessary to finance the retirement or further education of the children.

On the other hand, the companies, which until now, were too small to be listed or could not afford the cost, through our system can have wider number of shareholders and more liquidity in their stocks. This will provide the company in a longer term with an alternative financing in small communities. In the same time, the owners of a business can easily sell their part of business without the need of complicated procedures that could result in a loss of economic resources. The cost of incentive program will also be lower for the company since most likely, the largest part of credit coupon/discount amounts will be returned to the issuing company as a payment for new stocks.

An added benefit for both consumer and issuer is that through the system the generation of coupons and exchange of the coupons to investment will be unified. This in turn will result in lower cost of issuance and administration for the issuer and the consumer will receive a higher value for its coupons because of lower administration cost of exchange of coupons to stocks.

### SUMMARY OF INVENTION

The present invention shows a system and method for consumers to acquire stocks in a company by simply purchasing from the company and receiving credit coupons based on pre-determined percentage of purchase amount. The invention also presents a method for free trade of acquired stocks through an exchange. The present invention is adapted for implementation mainly on the Internet (WWW—world wide web), but it can handle also the off line purchases through consumer supplying the retailer with his/hers system participant id.

When a consumer purchases from a company, he or she informs the company about his or hers participant id or in case the consumer is not a registered participant, the consumer can register for such id thorough participating companies. The consumer can continue with the purchase as usual. The company will report the purchase and a pre-determined percentage of purchase will be credited as a coupon to the consumer under that issuer's company name in the exchangers computer system.

When the consumer has earned enough credit that equals or exceeds the current stock price of the issuer's company, the credit will be converted to stocks in the issuer's company through the stock generation algorithm and/or purchase of stocks on the exchange. The purchase price of the stocks will be reduced from consumer's credit. The stocks will be credited to consumer's stock portfolio on the central computerized exchange and the consumer can trade freely the stocks on the exchange.

The invention provides substantial benefits to both consumers and participating companies, which issue the coupons.

### OBJECTS AND ADVANTAGES

The object of the invention is to improve and solve problems of prior art consumer incentive systems and coupon programs as discussed above by increasing the loyalty of the consumer to the issuer of incentive programs/coupons, and also lower the cost of implementation of exchange program for consumer credit for investment alternatives by unifying the process.

The objects of the invention are achieved by providing a central exchange which based on the defined method and system will exchange the consumer earned credit with stocks in issuer's company either through the generation of new common stocks or the purchase of stocks from other stock owners. The exchange will also provide the consumer with an exit strategy for converting the stocks to cash by selling them on the exchange. Since in this system the consumer is also the shareholder of the issuing company, this fact will increase the loyalty of the consumer to the issuer of incentive program or coupon.

A further object of the invention is to provide the consumers with long time investment possibilities and potential investment appreciation through receiving stocks for the credits earned from purchase of goods. The ownership of stocks in local business can also generate a sense of interest and participation in the community, especially for the low-income families that generally have no possibilities to take part in local business environment and activities.

A further object of invention is to lower the cost of converting consumer's coupons/award system credits to investment instruments by unifying such procedure through the exchange.

A further object of invention is to provide the small and new companies with the stock exchange, which provides liquidity in their underlying stocks. This will provide the issuers with better financing alternatives and the financial institution with a better possibilities for the valuation of the issuer's business. The generated liquidity and market price for the stocks will also make possible the transfer of business to new owners in event of sale of business in more orderly fashion and prevents the loss of financial resources.

A further object of the invention is using a software method to register the investment awards or credit coupons that will be issued by issuers on a central exchange.

A further object of the invention is using a software method for a system that converts the investment awards or credit coupons to the stock in issuer's company.

Further objects and advantages of the present invention will be apparent from the following description in conjunction with the accompanying drawings. The drawings are designed solely for purposes of illustration and not as a definition of the limits of the invention, for which references should be made to the appended claims.

### BRIEF DESCRIPTION OF DRAWINGS

FIG. 1 is a block diagram of the concept. It shows the relation between the consumer both on-line and off-line to the exchange (implementation of this invention), issuers of coupons/purchase reward program and finally the connection to financial institutions such as banks.

FIG. 2 is the flow chart of the consumer purchase routine from issuer of coupon's company and the relation of company's internal routines to external modules for contacting the exchange for receiving consumer information and generating credit/reward coupons.

FIG. 3 is flow chart of the routine for transferring the consumer coupon/reward credit information from the issuer's system to the accounting system in the exchange.

FIGS. 4a and 4b are the flow charts for processing of all the coupon and consumer information that is received from different issuers according to FIG. 3 and crediting the amount to consumer credit file on the exchange. This routine also generates invoices from the exchange to the issuer's for the amount equal to generated amount of credit/reward, so the issuers can transfer the amount to the exchange.

FIGS. 5a and 5b is the algorithm for converting the consumer credit to the issuer's stocks. It will generate new stocks according to pre-defined price which is equal to running average price of N days, for example 30 days and/or the conversion will be done by purchasing stocks, if it is available on the exchange at a lower price that the pre-defined price. In case the new stocks are generated, the amount payable to the issuer's company for the price of stocks is also calculated and will be saved on a file for the latter payment of the funds.

FIG. 6 is the flow chart of trade routine. If in the process of consumer credit to stocks conversion, there will be stocks available at lower price than the pre-defined price; a buy order is entered at the exchange's trade system. The stocks will be purchased and buyer and seller will be credited accordingly.

FIG. 7 is the system with the main system files and databases.

### DETAILED DESCRIPTION

Reference Numerals in Drawings

10—Communication line, Internet

20—direct line (cashier, telephone, mail, . . . )

30—External programs/routines

110—Customer credit account database

115—Customer security account database

120—Customer currency account database

130—Security database

140—Trade order database

150—Transaction database

160—Payment for stock database

170—Receivable database file

180—Consumer coupon credit database

The present description of the invention is a simplified model, in order to demonstrate its functions and features. In this model, the company that generates the stock and arrange an alternative stock exchange for the trade of merchant stocks is referred to as the exchange.

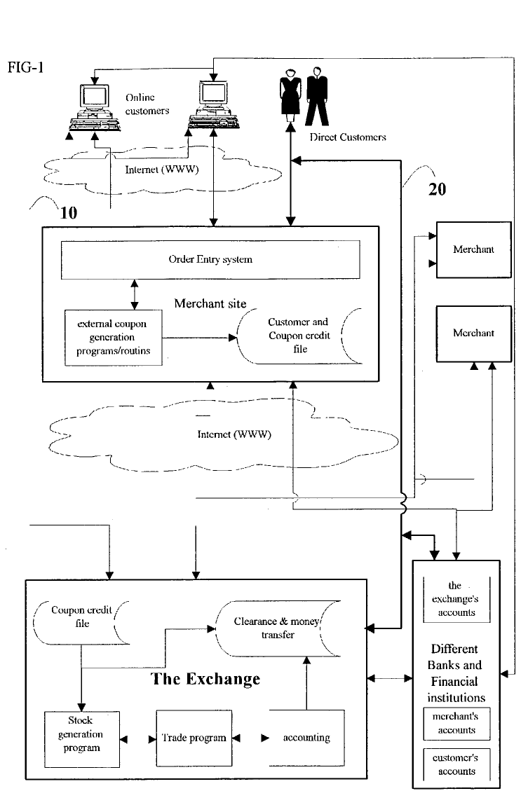

Referring now in detail to the drawing in FIG. 1, this is a block diagram representing a system 1 for crediting coupons to purchaser's account and generating stocks and the transfer of funds to and from consumers and merchants through connection to banks or other financial systems. As illustrated in FIG. 1, the customer places an order through merchants web site or other points of sale (Telephone, Fax, Cashier,).

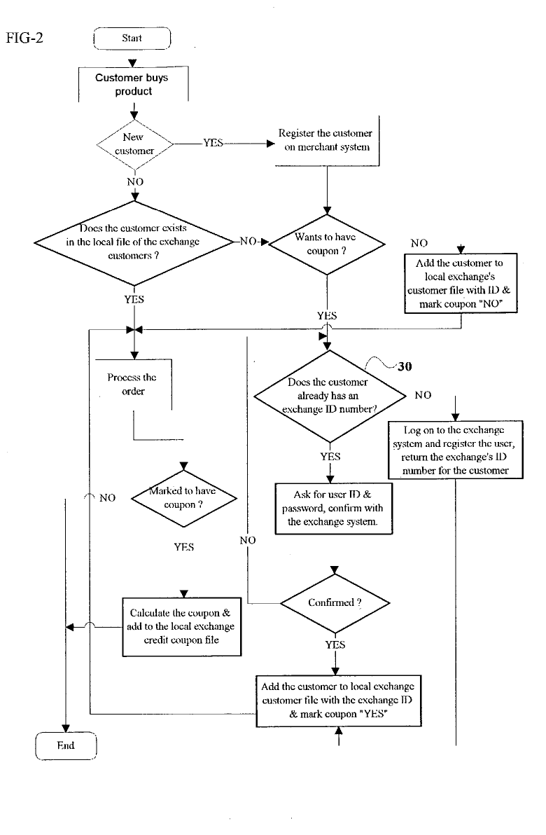

FIG. 2 shows how merchant registers the sale and a credit coupon is generated for the consumer through the exchange program modules that is executed on the merchants computerised order entry system. In this part of the system 1, the system 1 performs a control to determine if the consumer is a new customer for this particular merchant. In case of new customer, the customer will be presented with an alternative if he or she wants to participate in the exchange coupon/rewards program. If the customer does not want to participate, he or she will be registered as not participant. Otherwise, the consumer will be asked if he or she is a member of the exchange coupon program. In case the customer is a member of the exchange program, the system 1 will ask for the consumer unique user ID and registers the customer on the merchant's computer system. If the consumer is not member of the exchange program, the program automatically transfers the consumer to the exchange system so the consumer can register and a unique user ID number will be returned to the merchant site so the order processing can continue. Consumers which participate in coupon program will be credited a coupon that is based on the percentage of sale. The company issuing the reward/coupon will decide the percentage of sale that is applicable toward the program.

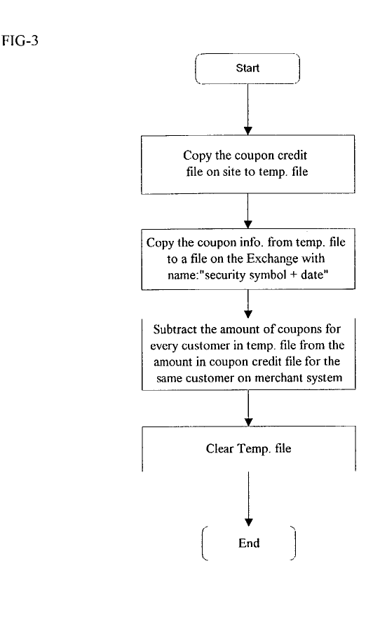

FIG. 3 shows how the information for generated coupons on every merchant's system is transferred to the exchange central system. The credit coupons file on the merchant system is copied to a temporary file. The temporary file is transferred to a day file on the exchange system. The amount of credits in temporary file is subtracted from the credits in the original file and the temporary file is cleared. There will be one such day file for every merchant that is member of the exchange. These day files can have names such as: “security symbol+date” to differentiate between files for different merchant and dates. For example a merchant which is listed on the exchange with symbol: ABC and transfers the information on 28/01/2001 will have a file by the name of: ABC28012001.

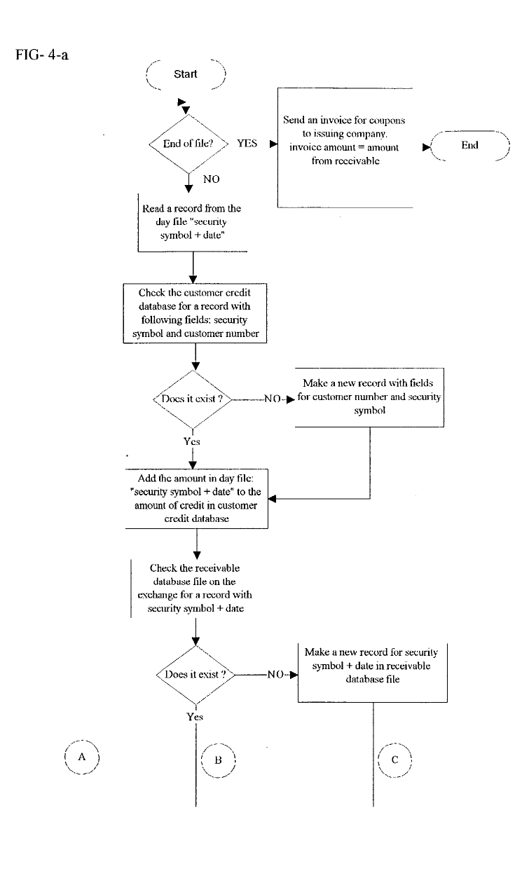

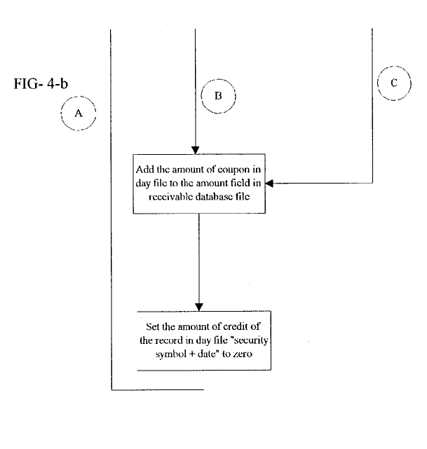

FIG. 4 shows how the credit coupon/reward system information that was send to the exchange as in FIG-3 is processed, the amount of coupon for every consumer is credited to the consumer credit file and it is added to the pervious credits from the issuer. The consumer credit file holds the information regarding the total amount of coupon credits earned by the consumer for respective issuers. The total amount of coupons for all customers for each merchant is also calculated and the balance is send to the merchant as an invoice, so the merchant can transfer the amount to the exchange which manages the funds on behalf of consumers. The amount is also registered in receivable database file 170 on the exchange. This routine repeats itself for all the day files on the system 1.

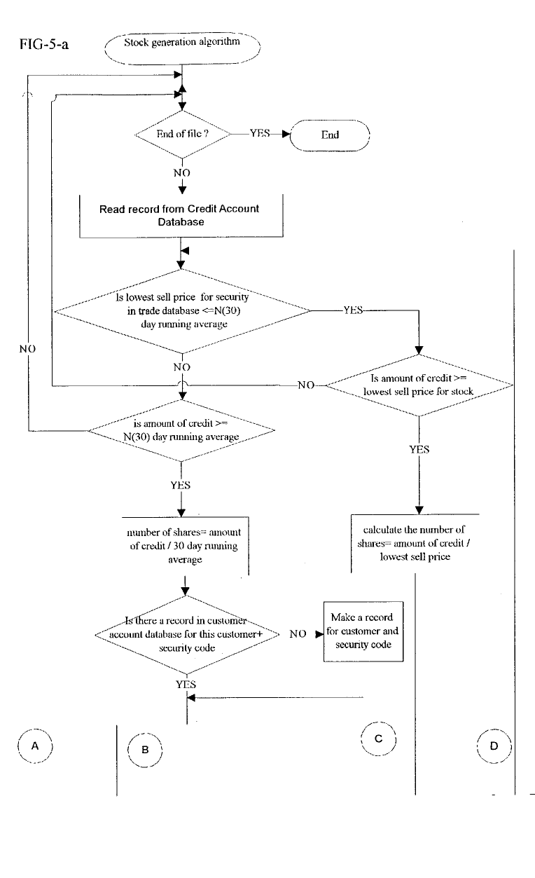

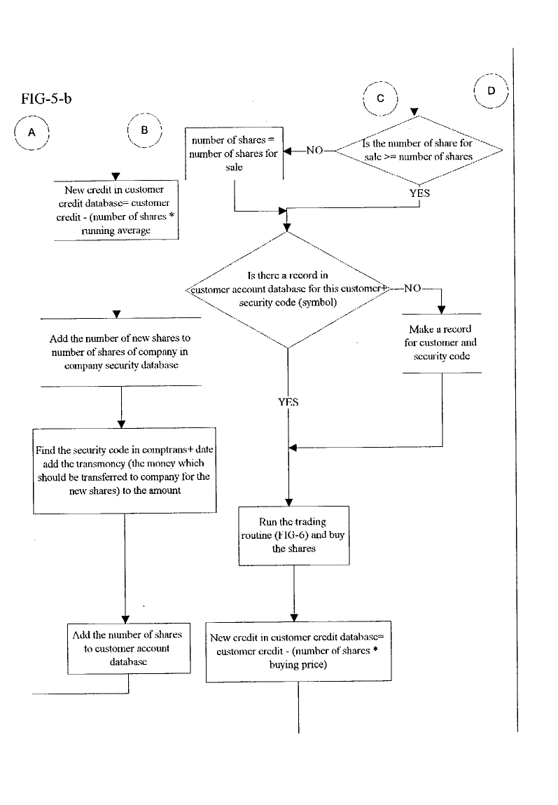

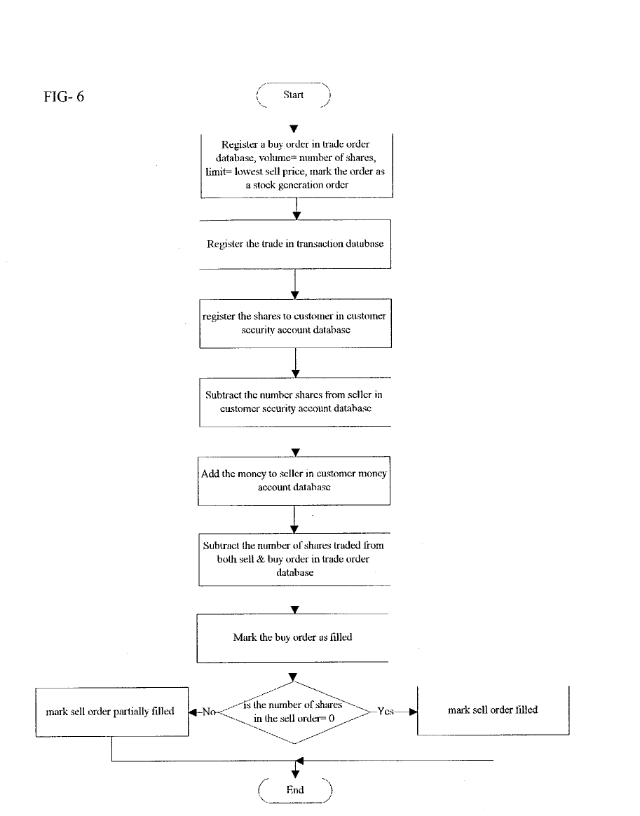

As shown in FIG. 5a, 5b and 6, the consumer coupon credit database 180 is checked on a daily basis. As soon as the consumer has enough credit to receive one or more stock in merchant company through either new stock issuance or buying on the exchange, the system 1 either will issues a number of shares or buys it on the exchange or a combination of the both alternatives. The stock issuance price is decided in the system 1 and equals to N days running average of all trades on the particular stock. In our example, the N is set to 30 days. For the first trade, when the issuing company's stock has not been previously traded on the exchange, the stock price will be set by an agreement between exchange and the issuing company. The first trade price can be a multiple of earning for example 4-5 time of earning per share or any other method, which will be acceptable to both parties. This method guarantees that the consumer can exchange their coupon credits to stocks even there are no stocks for sale on the market and that consumer will receive a fare price for his or her share. The shares will be credited it to the consumer and the amount will be deducted from consumer coupons credit. On those cases that the new stocks have been issued, the amount equal to the price of shares will be transferred from the exchange managed funds to the merchant account. On those instances that the shares will be bought on the exchange, the amount for the shares will be transferred to the seller account.

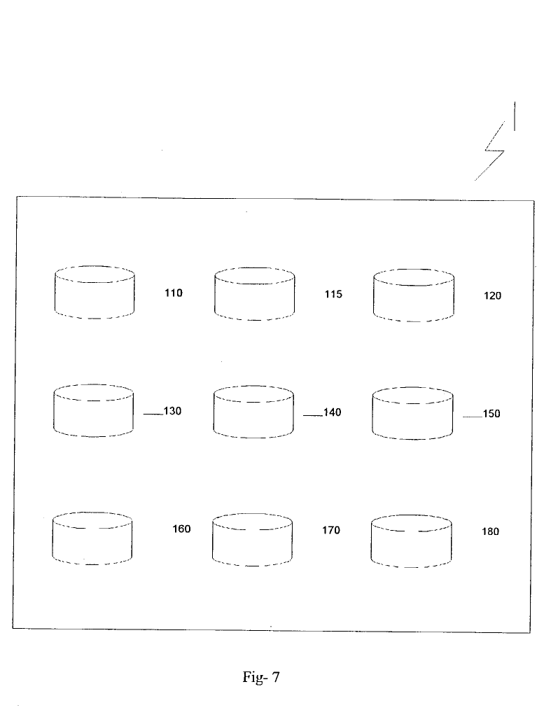

As shown in FIG. 7, in the above routine the systems 1 uses the following Databases:Customer credit account database 110, which keeps the information about customer credit coupons.

Customer security account database 115, that keeps the information about shares owned by customer.

Customer currency account database 120, that keeps the information about the amount of cash owned by customerSecurity database 130, that has all information regarding the issuing company and the number of shares issued.

Trade order database 140, which is a register of all trade orders placed on the exchange.

Transaction database 150, which registers all trade transaction which is done on the exchange.

Payment for stock database 160, which is a daily file which registers all the payment which should be made to the company for the new stock issuance.

Out side scope of consumer coupons clearance and stock issuance for the merchant companies, the exchange will function as a normal alternative stock exchange that brings customers to a computerised exchange for a free trade of their shares. The exchange will have all necessary functions of stock exchange such is registration of orders, making the transactions and all the accounting functions related to such activity. The exchange according to this method will actually combines all the function of a stock exchange, depository, clearing and brokerage in one organisation.

Operation of Invention

The manner of using this business method for coupons/award systems is as follows:Consumer will enter a purchase order at the merchants order system either on-line or off-line. At this point the merchants system will determine if the consumer is a new customer or not. If this is a new customer, the consumer will be presented with an option to participate in the coupon/reward system program. If the customer chooses to participate, the customer will be presented with a question to determine if the consumer is a member of the exchange. If the consumer is a member, the person will be asked to provide the unique user ID, which can consist of numbers, symbols or letter, that is provided by the exchange to the customer and the consumer will be registered on the merchant system as the participant in the coupon program. If the customer is not registered on the exchange, the consumer will be presented with the possibility to register and unique user ID will be returned to the merchant, so the consumer can be registered as a participant on the merchant system. In case, the consumer chooses not to participate in the coupon program, the customer will be registered on the issuers order system as a non-participant.

From this point, every time the consumer purchases from the issuer's of coupon, the amount of credit coupon will be automatically calculated by the system 1 and the amount will be reported to the exchange. The exchange will calculate the total amount of credits issued by the merchant and invoice the merchant's company accordingly.

When enough credit is earned by the consumer to equal the price of one or more shares of the stock, the credit will be converted by the exchange to issuing company's stock. This will be done either by issuing new common stocks or by the purchase of stocks that are for sale on the exchange, depending on the price of stocks. The consumer credit account will be deducted by the price of stocks and his stock portfolio will be credited by the stocks. The account of company issuing the stocks or/and the account for the seller of the stocks will be credited depending on the method of the conversion. If there is seller of the stocks, the seller's portfolio will be debited by the number of stocks. If new shares have been issued, the number of new shares will be added to the number of outstanding company shares.

The consumer can check/control all their accounts on the exchange such as coupon's credit account, stocks account (portfolio of different shares) and money account (which holds the proceeds from sales of the stocks) through on-line (Internet) or off-line (Telephone, fax, mail,). The consumer can freely place buy/sell orders for the stocks on the exchange and control his/hers investment.

Conclusion, Ramifications, and Scope

By unifying the process of coupon/reward generation, conversion to investment instrument in form of stocks in underlying company's stock and providing a platform for trade in these stocks, we provide the consumer and companies with:

A) A base of loyal customers who have active interest in the merchant since they are also shareholders through coupon credit program.

B) Companies will get a cost effective coupon/reward system since the automation of procedure will bring down the cost of implementation.

C) The company will get back most of the credit back through payment for the issuance of new stocks and the money can be uses for further investment and development.

D) The shares of the issuing company will become an active trading stocks, which makes easier for the small companies to find financing and for credit institutions and banks will become a lot easier to value/finance the company.

E) If the owners of a company will decide to sell the company, it will be easier to sell the stock with known value than selling a small company that is difficult to evaluate. For example in event of retirement of the owner, this will be beneficial to both buyers and sellers of a company and eliminate some the economic resource destruction that is associated with such process.

F) The reward for the consumer will not be a short-term discount but actually an investment that helps the low-income consumers to participate in the economic growth of the economy and companies. This in a long run can provide the consumers with means for financing retirement or collage funds for the children.

G) Consumers will learn about investment and investment activities. Since they will be shareholders in their local companies, they will have a better understanding of the needs of business community, which improves the spirit of the community.

While above description contains many specificities, these should not be construes as limitations on the scope of the invention, but rather as an exemplification of one preferred embodiment thereof. Many other variations are possible. For example, the system can be adapted for off-line use only. The customer will be issued with consumer card that the merchant can enter either manually or through scanning device in to the order system. The credits will then be reported through either manual or automatic process to the exchange.

Accordingly, the scope of the invention should be determined not by the embodiment(s) illustrated, but by the appended claims and their legal equivalents.

1. A method for converting purchase credit awards resulting from a purchase by a consumer of goods or service into ownership of stocks in the awards issuing company, comprising the steps of:
(a) Maintaining data files and software on the company issuing rewards/coupons computer system including;
(I) A participant file for consumers of said company issuing rewards/coupons, said participant file including an identifying ID number for the centralized exchange and a field for determining if the customer would like participate in the coupon/reward system, (II) Software for registration of said consumers in the said participant file, (III) Software for registration of said consumers that where not a previously member of the said centralized exchange on the said exchange and returning a unique ID number for registration in the said participant file, (IV) A credit coupon file, for registration of credit earned by said consumers, and (V) Software for calculation of credit earned by said consumers, as a percentage of sales and registration of the credit amount in the said credit coupon file.
(b) Maintaining a computer system for the said centralized exchange including following software and storage files; (I) A file for registration of the said consumers with unique ID number and personal information of consumer, (II) A file for registration of companies issuing rewards, (III) A file for registration of all earned credit by said consumers, (IV) A file for registration of all stocks owned by said consumers, (V) A file for registration of cash owned by said consumers, (VI) A file for registration of all buy/sell orders, (VII) A file for registration of all trades done on the said exchange, (VIII) A file for registration of payments to the said companies for new stock issuance, (IX) A file for addition of all credit earned by the said consumers, so the said companies can pay the said exchange for the credits, and (X) Software for placing buys and sells orders for the stocks on the said exchange.

2. The method of claim 1 wherein the step of converting the credit awards in to the stocks ownership includes the steps of: (I) Accessing a database to see if the said consumer has enough credits to purchase one or more stocks, (II) Calculating a price of new stock issuance based on the N day running average of all trades on the said stock on the exchange, (III) Comparing the said calculated price with the lowest sell price for the said stock on the exchange and if the said calculated price is lower than the said sell price, issue a new stock in the said company. Other wise buy the said stock on the exchange, (IV) Subtracting the amount of issued or bought said stocks from the credits earned by consumer, and (V) Adding the new stocks to the said registration file of stocks owned by consumer.

3. A method for converting purchase credit awards resulting from a purchase by a consumer of goods or service into ownership of stocks in the awards issuing company, comprising the steps of: Maintaining data files and software on a computer system including; i. A participant file, ii. Software for registration of consumers in the said participant file, iii. A credit coupon file, and iv. Software for calculation of credit earned by said consumers.

4. The method of claim 3 wherein the step of converting the credit awards in to the stocks ownership includes the steps of maintaining a file for registration of the said consumers with unique ID number and personal information of consumer.

5. The method of claim 3 wherein the step of converting the credit awards in to the stocks ownership includes the steps of maintaining a file for registration of companies issuing rewards.

6. The method of claim 3 wherein the step of converting the credit awards in to the stocks ownership includes the steps of maintaining a file for registration of all earned credit by said consumers.

7. The method of claim 3 wherein the step of converting the credit awards in to the stocks ownership includes the steps of maintaining a file for registration of all stocks owned by said consumers.

8. The method of claim 3 wherein the step of converting the credit awards in to the stocks ownership includes the steps of maintaining a file for registration of cash owned by said consumers.

9. The method of claim 3 wherein the step of converting the credit awards in to the stocks ownership includes the steps of maintaining a file for registration of all buy/sell orders.

10. The method of claim 3 wherein the step of converting the credit awards in to the stocks ownership includes the steps of maintaining a file for registration of all trades done on the said exchange.

11. The method of claim 3 wherein the step of converting the credit awards in to the stocks ownership includes the steps of maintaining a file for registration of payments to the said companies for new stock issuance.

12. The method of claim 3 wherein the step of converting the credit awards in to the stocks ownership includes the steps of maintaining a file for addition of all credit earned by the said consumers, so the said companies can pay the said exchange for the credits.

13. The method of claim 3 wherein the step of converting the credit awards in to the stocks ownership includes the steps of maintaining software for placing buys and sells orders for the stocks on the said exchange.

14. The method of claim 3 wherein the step of converting the credit awards in to the stocks ownership includes the steps of: (I) Accessing a database to see if the said consumer has enough credits to purchase one or more stocks, (II) Calculating a price of new stock issuance based on the N day running average of all trades on the said stock on the exchange, (III) Comparing the said calculated price with the lowest sell price for the said stock on the exchange and if the said calculated price is lower than the said sell price, issue a new stock in the said company. Other wise buy the said stock on the exchange, (IV) Subtracting the amount of issued or bought said stocks from the credits earned by consumer, and (V) Adding the new stocks to the said registration file of stocks owned by consumer.

15. A method comprising the steps of: (a) having a consumer purchase a product or services; and (b) converting purchase credit awards resulting from said purchase into ownership of stocks in the awards issuing company.

16. The method of claim 15 wherein the step of converting the credit awards in to the stocks ownership includes the steps of: (I) Accessing a database to see if the said consumer has enough credits to purchase one or more stocks, (II) Calculating a price of new stock issuance based on the N day running average of all trades on the said stock on the exchange, (III) Comparing the said calculated price with the lowest sell price for the said stock on the exchange and if the said calculated price is lower than the said sell price, issue a new stock in the said company. Other wise buy the said stock on the exchange, (IV) Subtracting the amount of issued or bought said stocks from the credits earned by consumer, and (V) Adding the new stocks to the said registration file of stocks owned by consumer.

17. The method of claim 15 wherein the step of converting the credit awards in to the stocks ownership includes the steps of: Maintaining data files and software on a computer system including; i. A participant file, ii. Software for registration of consumers in the said participant file, iii. A credit coupon file, and iv. Software for calculation of credit earned by said consumers.

18. The method of claim 15 wherein the step of converting the credit awards in to the stocks ownership includes the steps of: Maintaining data files and software on a computer system including; i. A participant file for consumers of said company issuing rewards/coupons, said participant file including an identifying ID number for the centralized exchange and a field for determining if the customer would like participate in the coupon/reward system, ii. Software for registration of said consumers in the said participant file, iii. Software for registration of said consumers that where not a previously member of the said centralized exchange on the said exchange and returning a unique ID number for registration in the said participant file, iv. A credit coupon file, for registration of credit earned by said consumers, and v. Software for calculation of credit earned by said consumers, as a percentage of sales and registration of the credit amount in the said credit coupon file.

19. The method of claim 15 wherein the step of converting the credit awards in to the stocks ownership includes the steps of: Maintaining a computer system for a centralized exchange including following software and storage files; (I) A file for registration of the said consumers with unique ID number and personal information of consumer, (II) A file for registration of companies issuing rewards, (III) A file for registration of all earned credit by said consumers, (IV) A file for registration of all stocks owned by said consumers, (V) A file for registration of cash owned by said consumers, (VI) A file for registration of all buy/sell orders, (VII) A file for registration of all trades done on the said exchange, (VIII) A file for registration of payments to the said companies for new stock issuance, (IX) A file for addition of all credit earned by the said consumers, so the said companies can pay the said exchange for the credits, and (X) Software for placing buys and sells orders for the stocks on the said exchange
